(19) United States
(12) Patent Application Publication
(10) Pub. No.: US 2021/0103905 A1
(43) Pub. Date: Apr. 8, 2021

(54) BEAUTY PRODUCT DISPENSING SYSTEM AND METHOD

(71) Applicant: Alliyson Charmaine Bonner, Richardson, TX (US)

(72) Inventor: Alliyson Charmaine Bonner, Richardson, TX (US)

(21) Appl. No.: 17/065,124

(22) Filed: Oct. 7, 2020

Related U.S. Application Data
(60) Provisional application No. 62/911,965, filed on Oct. 7, 2019.

(51) Int. Cl. G06Q 20/18; G06Q 20/20; G07F 11/02

(52) U.S. Cl. CPC G06Q 20/18; G07F 11/02; G06Q 20/204; G06Q 20/203

(57) ABSTRACT

A method and system of distributing and selling beauty care products using vending devices.

### BACKGROUND

### 1. Field

One or more embodiments of the present invention relate to a method and system of distributing and selling beauty care products.

### 2. Description of the Related Art

It is known in the art that cosmetic products are segmented into skin care products, hair care products, color cosmetics, fragrances, etc. These products are used to enhance the beauty of the consumers by rejuvenating skin, giving shine to the hair, and so on. Distribution channels such as supermarkets, department stores, etc., offer a wide array of cosmetic products and provide a medium for selection of the desired product.

The cosmetics products market is segmented on the basis of types, distribution channels, and geography in terms of value ($Billion). The market segments, by type, include skin care, hair care, color cosmetics, fragrance & deodorants, personal hygiene, oral hygiene, soap, bath & shower, sun care, and others.

The distribution channels of cosmetic product include supermarkets, pharmacy and drug stores, department stores, direct selling, specialty stores, internet retailing, beauty salons, and others.

Currently, the majority of beauty care products are distributed and sold from brick and mortar beauty supply stores or online establishments. The purchase of products from a brick and mortar store requires a system wherein the consumer must travel to the store during normal business hours, pick up products to be purchased and interact with a customer sales associate to complete the purchase.

The disadvantages of the brick and mortar system include the inefficiencies associated with customer travel to and from a store during business hours. Further, during the COVID-19 pandemic, stores may be closed to in-store customer traffic, eliminating this crucial part of the system.

Internet retailing is another system used to distribute and sell cosmetic products. This system relies on an online marketplace of sufficient quality to adequately display and describe the products being sold, as well as a secure method for paying for the desired items. Once the transactions have been completed online, the products must be packaged carefully and shipped to the customer in a timely fashion.

The disadvantages of the internet system include inadvertent inaccurate depictions and descriptions of the items intended for sale, as well as difficulty in updating websites with accurate inventory. Internet transactions are also prone to piracy and hacking resulting in theft of money and product. Also, the customer must wait for the product to arrive through conventional shipping means.

Further, previous attempts at providing systems for distributing hair care or cosmetic products, such as the method disclosed in U.S. Pat. No. 8,510,168, are directed to licensed hair care and cosmetic professionals. Indeed, a key element of the '168 patent is the requirement that any operator of the disclosed method be a verified licensed hair care or cosmetics professional.

Therefore, what is needed is an improved system for the distribution and sale of cosmetics and beauty care products to customers who are not licensed hair care or cosmetics professionals.

### SUMMARY

In view of what is known in the art, the inventor has developed a system for distributing and selling cosmetics and beauty care products to unlicensed consumers that overcomes the aforementioned disadvantages. The present beauty product dispensing system comprises a device, such as a vending machine that stores, exhibits, delivers and dispenses a packaged beauty product to a consumer upon request and confirmed payment. The device comprises a means for displaying the beauty product, such as a window or viewing screen; a means of selecting the beauty product, such as a touch screen, buttons or mobile device app; a mechanism for receiving payment for the beauty product; and a means for delivering and dispensing the product to the customer.

In one embodiment, the system includes the steps of browsing an inventory of beauty products available for sale on a vending machine type device; selecting a desired product or products; inputting payment for the products; initiating the device to deliver and dispense the product or products to the customer through a suitable delivery portal.

### BRIEF DESCRIPTION OF THE DRAWINGS

These and/or other aspects will become apparent and more readily appreciated from the following description of the embodiments, taken in conjunction with the accompanying drawings in which:

FIG. 1 is a depiction of a customer viewing beauty products available for sale at a vending machine.

### DETAILED DESCRIPTION

Reference will now be made in detail to embodiments, examples of which are illustrated in the accompanying drawings. In this regard, the present embodiments may have different forms and should not be construed as being limited to the descriptions set forth herein. Accordingly, the embodiments are merely described below, by referring to the figures, to explain aspects of the present invention.

Beauty products includes, but is not limited to, a range of products that are used to care for the face and body, lips and hair, or to accentuate or change the appearance of the face or body, lips and hair. The products include skin care, personal care, cosmetics and fragrance, hair extensions, lip sticks, and fingernails and polishes.

Vending machines include any automated machine configured to provide items upon receipt of payment. Payment can include cash, credit card, or online payment via an app installed on any suitable mobile device.

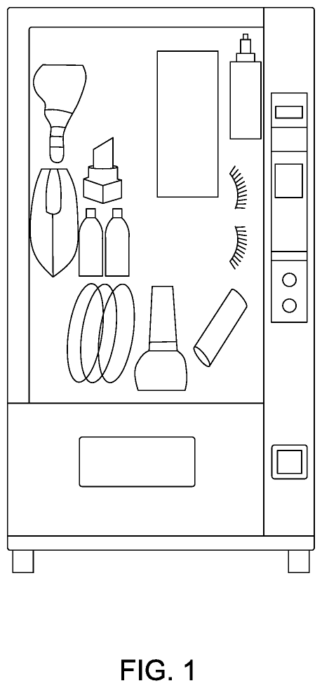

In one embodiment, as shown in FIG. 1, the present system includes the steps of a customer viewing products on display at a suitable device, such as a vending machine that has been configured to display beauty products; selection of a product or products through a suitable selection means; inputting payment for the selected product or products; and initiating the device to deliver and dispense said products to the customer.

In another embodiment, the present method comprises the steps of browsing an inventory of beauty products available for sale on a vending machine type device; selecting a desired product or products; inputting payment for the products; initiating the device to deliver and dispense the product or products to the customer through a suitable delivery portal.

The foregoing descriptions of specific embodiments of the present invention have been presented for purposes of illustration and description. They are not intended to be exhaustive or to limit the invention and method of use to the precise forms disclosed. It is understood that many modifications and variations are possible in light of the above teaching. The embodiment was chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

1. A method of distributing beauty products to a consumer comprising the steps of: browsing an inventory of beauty products available for sale at a vending device; selecting a desired product or products; inputting payment for the products; initiating the device to deliver and dispense the product or products to the customer through a suitable delivery portal.

2. The method of claim 1 wherein the beauty products are hair care or cosmetic products.

3. The method of claim 1 wherein the vending device is an apparatus configured to stock, display, and deliver beauty products upon selection and receipt of payment.
